(19) United States
(12) Patent Application Publication
(10) Pub. No.: US 2025/0157167 A1
(43) Pub. Date: May 15, 2025

(54) INFORMATION PROCESSING METHOD, INFORMATION PROCESSING DEVICE, AND NON-TRANSITORY COMPUTER READABLE RECORDING MEDIUM

(71) Applicant: PANASONIC INTELLECTUAL PROPERTY MANAGEMENT CO., LTD., Osaka (JP)

(72) Inventors: Minami NAKA, Osaka (JP); Tadamasa TOMA, Osaka (JP); Satoshi MATSUI, Kyoto (JP)

(73) Assignee: PANASONIC INTELLECTUAL PROPERTY MANAGEMENT CO., LTD., Osaka (JP)

(21) Appl. No.: 19/022,846

(22) Filed: Jan. 15, 2025

Related U.S. Application Data
(63) Continuation of application No. PCT/JP2023/026191, filed on Jul. 18, 2023.
(60) Provisional application No. 63/368,817, filed on Jul. 19, 2022.

(30) Foreign Application Priority Data
Jul. 7, 2023 (JP) 2023-112370

(51) Int. Cl. G06T 19/20; G06F 18/23; G06T 17/00

(52) U.S. Cl. CPC G06T 19/20; G06F 18/23; G06T 17/00; G06T 2219/008; G06T 2219/2021

(57) ABSTRACT

An information processing device acquires an input instruction to designate a boundary plane component that is a plane component of a boundary of a three-dimensional cutout region cut out from a three-dimensional model of an object on a two-dimensional plane on which the three-dimensional model is projected, generates a three-dimensional provisional model demarcated by the boundary plane component in the three-dimensional model, estimates a boundary normal component of the three-dimensional cutout region by correcting a shape of the three-dimensional provisional model, the boundary normal component being a component in a normal direction orthogonal to the two-dimensional plane, and cuts out a region demarcated by the boundary normal component from the three-dimensional provisional model, as the three-dimensional cutout region.

### FIELD OF INVENTION

The present disclosure relates to a technique for handling a three-dimensional model of an object.

### BACKGROUND ART

Patent Literature 1 discloses a three-dimensional (3D) model generation device that generates a 3D model of a subject with a volume intersection method based on camera videos of a zoom-in camera and a zoom-out camera, in which the 3D model is generated assuming that the subject exists outside an angle of view range of the zoom-in camera.

After the generation of the 3D model, processing for cutting out a part of a three-dimensional region desired by a user from the 3D model may be performed in accordance with an operation by the user. In this case, when the user is requested to perform an operation for designating the region from multiple directions, such a manner of designating a normal component of a boundary orthogonal to a plane in addition to the plane component of the boundary of the region, there arises a problem that burden of the operation increases.
Patent Literature 1: JP 2022-29730 A

### SUMMARY OF THE INVENTION

The present disclosure has been made to solve such a problem, and an object thereof is to provide a technique capable of accurately cutting out a target three-dimensional cutout region from a three-dimensional model of an object without inputting an operation for designating a region from multiple directions.

An information processing method according to one aspect of the present disclosure is an information processing method in a computer, the method including acquiring an input instruction to designate a boundary plane component that is a plane component of a boundary of a three-dimensional cutout region cut out from a three-dimensional model of an object on a two-dimensional plane on which the three-dimensional model is projected, generating a three-dimensional provisional model demarcated by the boundary plane component in the three-dimensional model, estimating a boundary normal component of the three-dimensional cutout region by correcting a shape of the three-dimensional provisional model, the boundary normal component being a component in a normal direction orthogonal to the two-dimensional plane, cutting out a region demarcated by the boundary normal component from the three-dimensional provisional model, as the three-dimensional cutout region, and outputting the three-dimensional cutout region.

According to the present disclosure, it is possible to accurately cut out a target three-dimensional cutout region from a three-dimensional model of an object without inputting an operation for designating a region from multiple directions.

### BRIEF DESCRIPTION OF THE DRAWINGS

FIG. 1 is a block diagram illustrating one example of a configuration of an information processing system according to a first embodiment of the present disclosure.

FIG. 2 is a flowchart illustrating one example of processing of an information processing device according to the first embodiment.

FIG. 3 is a diagram illustrating one example of a display screen displayed on a display when a boundary plane component is designated.

FIG. 4 is a flowchart illustrating details of processing for generating a three-dimensional provisional model described in step S2 in FIG. 2.

FIG. 5 is a diagram for describing processing for extracting a point surrounded by vertexes of the boundary plane component.

FIG. 6 is a flowchart illustrating details of cutout processing described in step S3 in FIG. 2.

FIG. 7 is a diagram illustrating one example of a display screen of a three-dimensional cutout region projected on a two-dimensional plane.

FIG. 8 is a flowchart illustrating details of the cutout processing according to a second embodiment.

FIG. 9 is a diagram illustrating a plurality of object elements obtained by dividing a three-dimensional provisional model.

### DETAILED DESCRIPTION

### (Knowledge Underlying Present Disclosure)

In a case where a worker performs a work on a target object at a work site, the worker may proceed with the work while checking an instruction from a remote person outside the work site. In this case, if the remote person can check which part of the target object the worker is looking at, the remote person can smoothly instruct the worker. In order to achieve this situation, for example, when an imaging device, such as an action camera or a smart glass, is attached to the head of the worker and a video of the work site captured by the imaging device is transmitted in real time to a remote terminal of the remote person, the remote person can check which part of the target object the worker is looking at.

However, at some work sites, it is prohibited to output a video to the outside from the viewpoint of security. In this case, there is a problem that the remote person cannot check the portion looked at by the worker.

Therefore, the present inventor has studied a technique of reproducing a three-dimensional model of a target object in a virtual space, capturing the three-dimensional model with a virtual camera synchronized with the position and posture of a worker at a site, and displaying the obtained virtual camera video on a remote terminal of a remote person.

Further, there are needs for cutting out a partial region from the three-dimensional model reproduced in this manner and observing the region in detail. For example, in a certain case, some parts constituting a target object are observed in detail. In this case, there is a conceivable method for causing a user to input an operation for designating a region to be cut out from the image of the three-dimensional model displayed on a display and cutting out the designated region from the three-dimensional model.

In the case of adopting this method, a boundary in a normal direction orthogonal to a projection surface of the three-dimensional model cannot be demarcated only by designating the boundary on the image of the three-dimensional model viewed from a specific direction (for example, a front direction), and the region cannot be three-dimensionally cut out. Therefore, a method is conceivable with which a three-dimensional model viewed from a direction different from the specific direction is displayed on the display, and an operation for designating the boundary in the normal direction line by line is input to the user.

However, with this method, since the operation for designating the boundary from a large number of directions is required, the burden on the user increases. Further, with this method, if the shape of the region to be cut out in the normal direction is complicated, the burden on the user further increases.

Therefore, the present inventor has obtained knowledge that the above-described problem is solved by acquiring a boundary designated by a user on an image of a three-dimensional model viewed from a specific direction as a boundary plane component, generating a three-dimensional provisional model that provisionally indicates a region to be cut out from the acquired boundary plane component, and estimating a component in a normal direction of the boundary based on the three-dimensional provisional model, and has arrived at the present disclosure.

(1) An information processing method according to one aspect of the present disclosure is an information processing method in a computer, the method including acquiring an input instruction to designate a boundary plane component that is a plane component of a boundary of a three-dimensional cutout region cut out from a three-dimensional model of an object on a two-dimensional plane on which the three-dimensional model is projected, generating a three-dimensional provisional model demarcated by the boundary plane component in the three-dimensional model, estimating a boundary normal component of the three-dimensional cutout region by correcting a shape of the three-dimensional provisional model, the boundary normal component being a component in a normal direction orthogonal to the two-dimensional plane, cutting out a region demarcated by the boundary normal component from the three-dimensional provisional model, as the three-dimensional cutout region, and outputting the three-dimensional cutout region.

According to this configuration, when a user designates the boundary plane component of the region desired to be cut out in the two-dimensional plane on which the three-dimensional model of the object is projected, the three-dimensional provisional model is generated from the three-dimensional model demarcated by the boundary plane component. Then, the boundary normal component is estimated by correcting the shape of the three-dimensional provisional model, and the region demarcated by the boundary normal component is cut out as the three-dimensional cutout region. Therefore, the user can cut out the three-dimensional cutout region only by inputting the input instruction of the boundary of the three-dimensional cutout region when viewing the three-dimensional model from one direction. This results in a target three-dimensional cutout region being accurately cut out from the three-dimensional model of the object without inputting an operation for designating a boundary from multiple directions.

(2) In the information processing method according to (1), the estimating the boundary normal component includes acquiring three-dimensional master data of the object, detecting, in the three-dimensional provisional model, a point conforming to the three-dimensional master data by matching the three-dimensional master data with the three-dimensional provisional model, and estimating the normal component of the conforming point as the boundary normal component.

According to this configuration, by matching the three-dimensional provisional model and the three-dimensional master data, the point conforming to the three-dimensional master data is extracted from the three-dimensional provisional model, and the conforming point is estimated as the boundary normal component, thereby accurately estimating the boundary normal component.

(3) In the information processing method according to (2), the matching includes detecting a feature point of the three-dimensional master data and a feature point of the three-dimensional provisional model, and comparing a feature amount of the feature point of the three-dimensional master data with a feature amount of the feature point of the three-dimensional provisional model, and detecting the feature point of the three-dimensional master data matching with the feature point of the three-dimensional provisional model, and detecting the feature point of the three-dimensional provisional model at which the matching feature point can be detected, as the conforming point.

According to this configuration, since the boundary normal component is estimated by matching the feature amount of the three-dimensional master data with the feature amount of the three-dimensional provisional model, the boundary normal component can be estimated more accurately.

(4) In the information processing method according to (2), the three-dimensional master data may be three-dimensional computer aided design (CAD) data of the object.

According to this configuration, since the three-dimensional CAD data is adopted as the three-dimensional master data, the boundary normal component can be estimated more accurately.

(5) In the information processing method according to (1), the estimating the boundary normal component includes dividing the three-dimensional provisional model into a plurality of object elements constituting the object, identifying, among the plurality of object elements, one object element disposed on a nearest side of the two-dimensional plane, and determining the boundary normal component in a component in a normal direction of a boundary of the one object element.

In a case where the three-dimensional model includes the plurality of object elements, the user inputs the input instruction of the boundary plane component in a state where the three-dimensional model is displayed so that the object element desired to be cut out is displayed on the nearest side. According to this configuration, the three-dimensional provisional model is divided into a plurality of object elements, and the boundary normal component is determined from a component in a normal direction of the boundary of the object element located on the nearest side among the plurality of divided object elements, thereby accurately estimating the boundary normal component.

(6) In the information processing method according to (5), the plurality of object elements may be obtained by inputting the three-dimensional provisional model to an object recognizer.

According to this configuration, since the three-dimensional provisional model is divided into the plurality of object elements using the object recognizer, the plurality of object elements can be accurately divided.

(7) In the information processing method according to (5), the plurality of object elements may be obtained by clustering the three-dimensional provisional model.

According to this configuration, since the three-dimensional provisional model is divided into the plurality of object elements by clustering the three-dimensional provisional model, such division can be easily achieved.

(8) In the information processing method according to any one of (1) to (7), the boundary plane component includes a plurality of sides partitioned by a plurality of vertexes, the generating the three-dimensional provisional model may include calculating, for a plurality of side vectors corresponding respectively to the plurality of sides, outer products of attention point vectors and the plurality of side vectors, the attention point vectors connecting start points of the plurality of side vectors to attention points, the attention points indicating respectively all points constituting the three-dimensional model, extracting, from all of the points, an attention point at which all of the outer products calculated respectively for the plurality of side vectors are positive, and identifying the extracted attention point as a point of the three-dimensional provisional model.

According to this configuration, the three-dimensional provisional model can be easily generated by accurately identifying a point inside the boundary plane component.

(9) An information processing device according to another aspect of the present disclosure is an information processing device including a processor, in which the processor acquires an input instruction to designate a boundary plane component that is a plane component of a boundary of a three-dimensional cutout region cut out from a three-dimensional model of an object on a two-dimensional plane on which the three-dimensional model is projected, generates a three-dimensional provisional model demarcated by the boundary plane component in the three-dimensional model, estimates a boundary normal component of the three-dimensional cutout region by correcting a shape of the three-dimensional provisional model, the boundary normal component being a component in a normal direction orthogonal to the two-dimensional plane, cuts out a region demarcated by the boundary normal component from the three-dimensional provisional model, as the three-dimensional cutout region, and outputs the three-dimensional cutout region.

This configuration can provide the information processing device that accurately cut out a target three-dimensional cutout region from the three-dimensional model of the object without inputting an operation for designating a boundary from multiple directions.

(10) An information processing program according to another aspect of the present disclosure is an information processing program for causing a computer to perform processing of acquiring an input instruction to designate a boundary plane component that is a plane component of a boundary of a three-dimensional cutout region cut out from a three-dimensional model of an object on a two-dimensional plane on which the three-dimensional model is projected, generating a three-dimensional provisional model demarcated by the boundary plane component in the three-dimensional model, estimating a boundary normal component of the three-dimensional cutout region by correcting a shape of the three-dimensional provisional model, the boundary normal component being a component in a normal direction orthogonal to the two-dimensional plane, cutting out a region demarcated by the boundary normal component from the three-dimensional provisional model, as the three-dimensional cutout region, and outputting the three-dimensional cutout region.

This configuration can provide the information processing program for accurately cutting out a target three-dimensional cutout region from the three-dimensional model of the object without inputting an operation for designating a boundary from multiple directions.

The present disclosure can be also implemented as an information processing system that is operated by such an information processing program. It is needless to say that such a computer program can be distributed via a computer-readable non-transitory recording medium such as a CD-ROM, or via a communication network such as the Internet.

Each of embodiments to be described below illustrates a specific example of the present disclosure. Numerical values, shapes, components, steps, an order of steps, and the like shown in the embodiments below are one example, and are not intended to limit the present disclosure. Furthermore, a component that is not described in an independent claim representing the highest concept among components in the embodiments below will be described as an arbitrary component. In all the embodiments, respective contents can be combined.

### First Embodiment

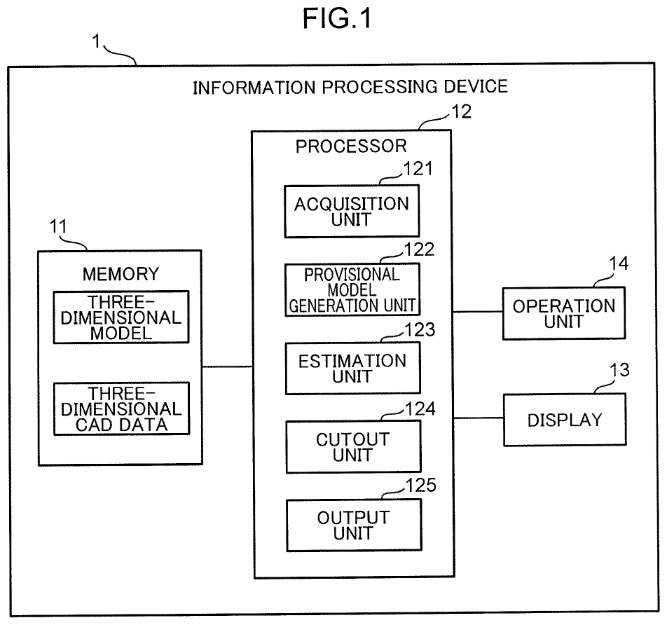

FIG. 1 is a block diagram illustrating one example of a configuration of an information processing system in a first embodiment of the present disclosure.

An information processing device 1 includes a memory 11, a processor 12, a display 13, and an operation unit 14. The memory 11 stores a three-dimensional model and a three-dimensional computer aided design (CAD) data. The three-dimensional CAD data is an example of master data.

The three-dimensional model is, for example, a model obtained by reproducing a target object in a virtual space. The three-dimensional model may include three-dimensional point cloud data indicating the shape of the target object. The three-dimensional model may be configured by a three-dimensional mesh model whose surface is expressed by a plurality of meshes by performing mesh processing on the point cloud data. The three-dimensional model may include three-dimensional object data in which a texture image obtained by imaging the surface of the target object is pasted to three-dimensional mesh data. The virtual space is a virtual three-dimensional space constructed in a computer.

An example of the target object includes a product assembled by a worker in a factory. Examples of the product include an electrical appliance, iron, and an automobile. Examples of the electrical appliance include a television, a refrigerator, and a washing machine. However, these are examples, and the target object may be equipment installed at a site where a worker works. Examples of the equipment include a manufacturing line for manufacturing an electrical appliance, an automobile, and iron.

The three-dimensional model is generated in advance, for example, by scanning a target object using a three-dimensional scanner, and is stored in the memory 11.

The three-dimensional CAD data is design data of the target object. For example, the three-dimensional CAD data includes data three-dimensionally representing shapes of a plurality of object elements constituting the target object, and a disposing relationship of each object element.

The processor 12 is constituted by, for example, a central processing unit (CPU). The processor 12 includes an acquisition unit 121, a provisional model generation unit 122, an estimation unit 123, a cutout unit 124, and an output unit 125.

The acquisition unit 121 acquires an input instruction to designate a boundary plane component that is a plane component of a boundary of a three-dimensional cutout region cut out from a three-dimensional model of the target object in a two-dimensional plane on which the three-dimensional model is projected. The acquisition unit 121 renders the three-dimensional model on the two-dimensional plane to project the three-dimensional model on the two-dimensional plane and to generate a display screen of the three-dimensional model, and displays the generated display screen on the display 13.

A user uses the operation unit 14 to input a boundary indicating a region to be cut out from a projection image of the three-dimensional model included in the display screen displayed on the display 13. The acquisition unit 121 acquires information indicating the input boundary as the input instruction to designate the boundary plane component. The information indicating the boundary includes two-dimensional coordinate data indicating the position of the boundary on the two-dimensional plane. Therefore, the input instruction includes the two-dimensional coordinate data indicating the position of the boundary on the two-dimensional plane. An example of the two-dimensional coordinate data indicating the position of the boundary may include coordinate data of all points of the boundary or coordinate data indicating the position of a vertex of the boundary. For example, when the boundary has a quadrangular shape, coordinate data of four vertexes of the quadrangle is adopted as the coordinate data indicating the position of the boundary.

The boundary plane component includes the two-dimensional coordinate data indicating the position of the boundary. For example, in a case where the input instruction includes coordinate data indicating positions of four vertexes of the boundary, the boundary plane component includes two-dimensional coordinate data indicating sides of a quadrangle surrounded by the four vertexes.

The two-dimensional plane is a plane set in a three-dimensional virtual space where a three-dimensional model is placed. The position and attitude of the two-dimensional plane are configured to be changeable in accordance with the position and attitude of a virtual camera used when the three-dimensional model is rendered. The acquisition unit 121 acquires a user's instruction input to the operation unit 14 to change the position and attitude of the virtual camera, and changes the position and attitude of the two-dimensional plane in accordance with the acquired instruction. As a result, the user can cause the display 13 to show the projection image of the three-dimensional model viewed from any direction on.

The provisional model generation unit 122 generates a three-dimensional provisional model demarcated by the boundary plane component in the three-dimensional model. The three-dimensional provisional model includes points, whose positions on the two-dimensional plane are located inside the boundary plane component, among all the points constituting the three-dimensional model. This three-dimensional provisional model is a model in which a normal component orthogonal to the two-dimensional plane is provisionally indicated, and is a model in which a three-dimensional cutout region is provisionally indicated.

The estimation unit 123 estimates a boundary normal component of the three-dimensional cutout region by correcting the shape of the three-dimensional provisional model. The boundary normal component is a normal component orthogonal to the two-dimensional plane.

Here, the estimation unit 123 acquires the three-dimensional CAD data of the target object from the memory 11, three-dimensionally matches the three-dimensional CAD data with the three-dimensional provisional model, and detects a point conforming to the three-dimensional CAD data in the three-dimensional provisional model. Then, the estimation unit 123 estimates a normal component of the detected conforming point as the boundary normal component.

The matching includes processing for detecting a feature point of the three-dimensional CAD data and a feature point of the three-dimensional provisional model, and processing for comparing a feature amount of the feature point of the three-dimensional CAD data with a feature amount of the feature point of the three-dimensional provisional model. The feature point is detected using an algorithm such as Scale-Invariant Feature Transform (SIFT), Speeded Up Robust Features (SURF), or Oriented FAST and Rotated BRIEF (ORB). As the feature amount, a feature amount in accordance with the algorithm, that is, the a SIFT feature amount, a SURF feature amount, or an ORB feature amount can be adopted. Further, the feature point may be a feature point indicating an edge.

An example of the matching processing includes a method for comparing the feature amount of the feature point of the three-dimensional CAD data with the feature amount of the feature point of the three-dimensional provisional model, detecting, in the three-dimensional CAD data, the feature point matching with the feature point of the three-dimensional provisional model, and detecting, as the conforming point, the feature point of the three-dimensional provisional model at which the matching feature point can be detected. In the matching processing, feature point matching for matching feature points having the highest similarity using nearest neighbor search or the like can be adopted. The estimation unit 123 detects, as the boundary normal component of the three-dimensional cutout region, a normal component of a feature point, at which a conforming point has been detected, in the three-dimensional CAD data, among all points of the three-dimensional provisional model.

The cutout unit 124 cuts out a region demarcated by the boundary normal component estimated by the estimation unit 123 from the three-dimensional provisional model, as a three-dimensional cutout region. The three-dimensional cutout region is a model cut out from the three-dimensional model in accordance with the input instruction from the user. The data of the three-dimensional cutout region has the same structure as the data structure of the three-dimensional model that is a cutout source.

The output unit 125 outputs the three-dimensional cutout region cut out by the cutout unit 124. For example, the output unit 125 may save the three-dimensional cutout region in the memory 11. The output unit 125 may output a display image obtained by projecting the three-dimensional cutout region on the two-dimensional plane to the display 13. As a result, the three-dimensional cutout region is displayed on the display 13.

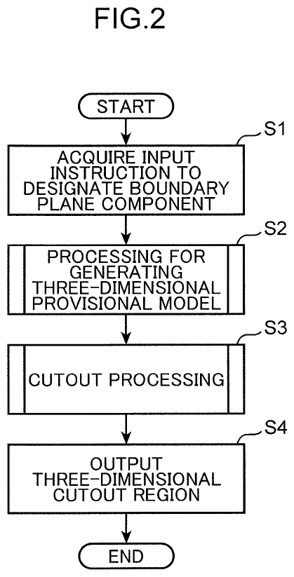

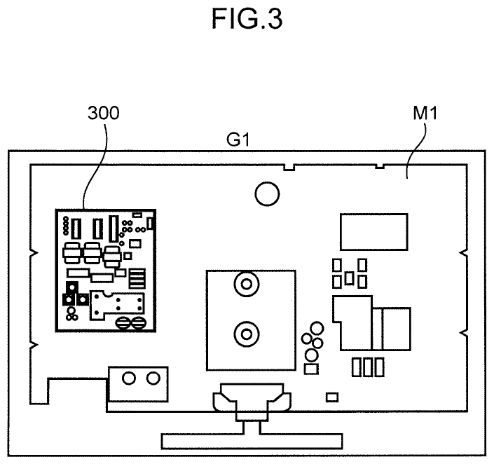

FIG. 2 is a flowchart illustrating one example of processing of the information processing device 1 according to the first embodiment. In step S1, the acquisition unit 121 acquires an input instruction, from the user, to designate the boundary plane component in the operation unit 14. FIG. 3 is a diagram illustrating one example of a display screen G1 displayed on the display 13 when the boundary plane component is designated. The display screen G1 shows a three-dimensional model M1 projected on the two-dimensional plane. This three-dimensional model M1 is a three-dimensional model indicating an internal structure of a television during assembly. The user operates the operation unit to input a boundary 300 onto the display screen G1. Here, a quadrangular frame surrounding an electronic component unit disposed on a substrate constituting the three-dimensional model M1 is input as the boundary 300. When the user inputs an operation for changing a line of sight on the display screen G1, the attitude of the virtual camera is changed accordingly. Further, when the user inputs an operation for changing a magnification on the display screen G1, the position of the virtual camera is changed accordingly. As a result, the user can view the three-dimensional model M1 from any direction and position. In this example, the line of sight is set in a front direction that is the normal direction of the substrate of the three-dimensional model M1. In this case, the two-dimensional plane is parallel to the substrate. Here, the boundary 300 is input so as to surround the electronic component unit, but this is an example, and the user can designate any region in the three-dimensional model M1. In addition, the boundary 300 may have any shape, such as a triangle, a pentagon, a circle, an ellipse, and a free closed curve, in addition to the quadrangle.

In next step S2, the provisional model generation unit 122 performs three-dimensional provisional model generation processing for generating a three-dimensional provisional model from the boundary plane component indicated by the input instruction. Details of this processing will be described later.

In next step S3, the estimation unit 123 and the cutout unit 124 perform cutout processing for cutting out a three-dimensional cutout region from the three-dimensional provisional model. Details of this processing will be described later.

In next step S4, the output unit 125 outputs the three-dimensional cutout region cut out by the cutout processing. For example, the output unit 125 may causes the display 13 to indicate a display image obtained by projecting the three-dimensional cutout region on the two-dimensional plane.

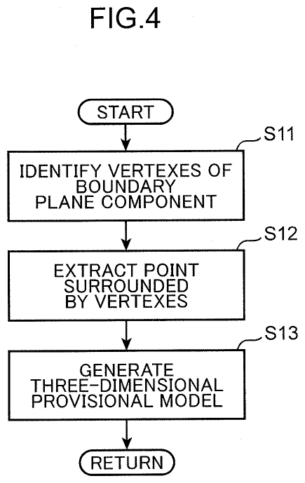

FIG. 4 is a flowchart illustrating details of processing for generating the three-dimensional provisional model described in step S2 of FIG. 2. In step S11, the provisional model generation unit 122 identifies a plurality of vertexes of the boundary plane component. In the example of FIG. 3, since the boundary 300 has a quadrangular shape, four vertexes constituting the quadrangle are identified as the vertexes of the boundary plane component. Note that in a case where the boundary 300 has a shape having no vertex such as a free closed surface, the provisional model generation unit 122 may identify key points on the boundary 300 as the vertexes. For example, the provisional model generation unit 122 may identify points at which the curvature greatly changes as the key points.

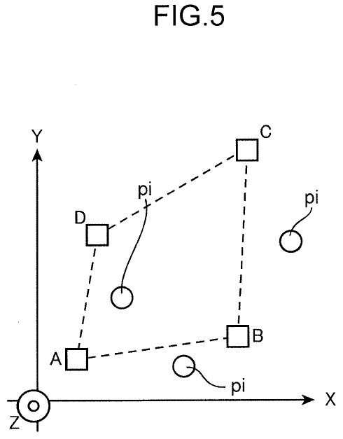

In next step S12, a point surrounded by the identified vertexes is extracted from the three-dimensional model M1. FIG. 5 is a diagram for describing processing for extracting the point surrounded by vertexes of the boundary plane component. In FIG. 5, the X and Y axes are two-dimensional coordinate axes set on the two-dimensional plane on which the three-dimensional model M1 is projected. The Z axis is a coordinate axis in the normal direction orthogonal to the two-dimensional plane.

In FIG. 5, the boundary plane component includes a quadrangle ABCD defined by vertexes A, B, C, and D. Attention points pi respectively indicate all points constituting the three-dimensional model M1. In a case where the three-dimensional model M1 is configured by a mesh model, the vertexes of the mesh are adopted as the attention points pi.

The provisional model generation unit 122 calculates, for the plane component of the attention points pi, outer products of side vectors corresponding to respective sides of the quadrangle ABCD and the attention point vectors connecting start points of the side vectors to the attention points pi. Specifically, the provisional model generation unit 122 calculates an outer product of a side vector AB and an attention point vector Api, an outer product of a side vector BC and an attention point vector Bpi, an outer product of a side vector CD and an attention point vector Cpi, and an outer product of a side vector DA and an attention point vector Dpi. The provisional model generation unit 122 extracts the attention point pi at which all the obtained four outer products are positive as a point in the boundary plane component. On the other hand, the provisional model generation unit 122 deletes the attention point pi at which at least one of the obtained four outer products is 0 or smaller as a point outside the boundary plane component.

In next step 513, the provisional model generation unit 122 generates a three-dimensional model including the remaining attention points pi as the three-dimensional provisional model. The three-dimensional provisional model includes points at which the plane component is identified but the normal component orthogonal to the two-dimensional plane is provisionally determined. The three-dimensional provisional model is temporarily stored in the memory 11.

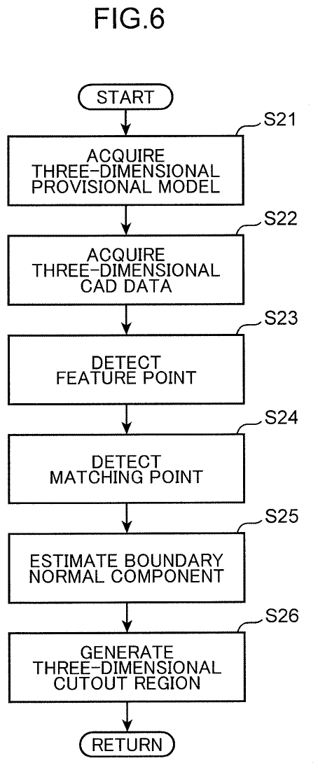

FIG. 6 is a flowchart illustrating details of the cutout processing in step S3 of FIG. 2. In step 521, the estimation unit 123 acquires the three-dimensional provisional model generated by the provisional model generation unit 122 from the memory 11.

In next step S22, the estimation unit 123 acquires three-dimensional CAD data from the memory 11.

In next step S23, the estimation unit 123 detects a feature point from each of the three-dimensional provisional model and three-dimensional CAD data. As described above, the feature point is detected using an algorithm such as SIFT or ORB. In a case where the three-dimensional model is constituted by a mesh model, the three-dimensional provisional model is also constituted by a mesh model. Therefore, the feature point is calculated for each vertex of the mesh constituting the three-dimensional provisional model.

In next step S24, the estimation unit 123 detects the feature point of the three-dimensional CAD data matching with the feature point of the three-dimensional provisional model by comparing the feature amount of the feature point of the three-dimensional provisional model with the feature amount of the feature point of the three-dimensional CAD data.

In next step S25, the estimation unit 123 estimates a normal component of a feature point, among the feature points of the three-dimensional provisional model, at which a matching feature point has been detected in the three-dimensional CAD data, as a boundary normal component of the three-dimensional cutout region.

In next step S26, the cutout unit 124 extracts a point surrounded by the boundary normal components from the three-dimensional provisional model, and generates a three-dimensional model including the extracted point as the three-dimensional cutout region. When step S26 ends, the processing proceeds to step S4 of FIG. 2.

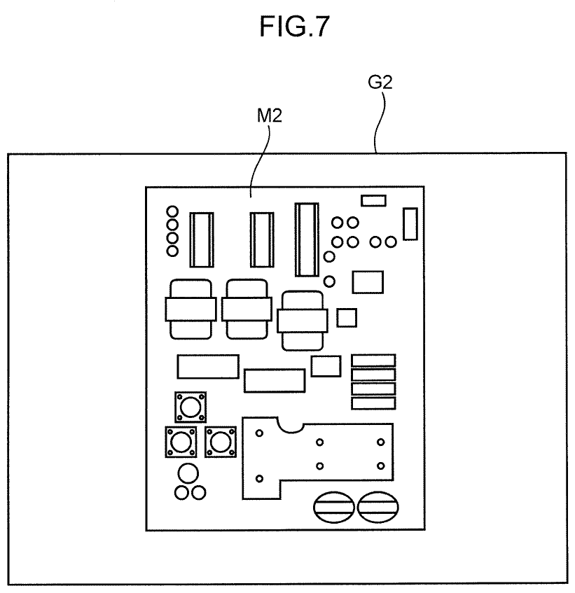

FIG. 7 is a diagram illustrating one example of a display screen G2 of the three-dimensional cutout region M2 projected on the two-dimensional plane. The display screen G2 shows the three-dimensional cutout region M2 generated by cutting out a region surrounded by the boundary 300 on the display screen G1 illustrated in FIG. 3. On the display screen G2, since the line of sight is set in the front direction of the three-dimensional cutout region M2, the three-dimensional cutout region M2 viewed from the front direction is displayed. The user can also cause the display 13 to show the three-dimensional cutout region M2 by setting the line of sight in a direction intersecting the three-dimensional cutout region M2. As a result, the user can check the shape of the height of the three-dimensional cutout region M2.

As described above, according to the present embodiment, the user can cut out the three-dimensional cutout region M2 only by inputting the input instruction of the boundary of the three-dimensional cutout region M2 at a time of viewing the three-dimensional model M1 from one direction. This results in the target three-dimensional cutout region M2 being accurately cut out from the three-dimensional model of the object without inputting the operation for designating a boundary from multiple directions.

In the present embodiment, by matching the three-dimensional provisional model and the three-dimensional CAD data, the point conforming to the three-dimensional master data is extracted from the three-dimensional provisional model, and the set of the conforming points is estimated as the boundary normal components, thereby accurately estimating the boundary normal component.

### Second Embodiment

In the second embodiment, a three-dimensional cutout region M2 is cut out by dividing a three-dimensional provisional model into a plurality of object elements. Note that, in the present embodiment, the same components as those in the first embodiment is denoted by the same reference numerals, and description thereof will be omitted. In the present embodiment, FIG. 1 is used as a block diagram.

FIG. 1 is referred to. The estimation unit 123 divides the three-dimensional provisional model into a plurality of object elements. The object elements correspond respectively to a plurality of parts constituting a target object. For example, in a case where the three-dimensional provisional model is an electronic component unit, a circuit board, an integrated circuit disposed on the circuit board, a connector group disposed on the circuit board, a circuit element group such as resistors disposed on the circuit board, and the like correspond to the object elements. However, the object elements are examples, and may be configured by any components of the target object.

The estimation unit 123 identifies one object element disposed on the nearest side with respect to the two-dimensional plane among the plurality of object elements, and determines the boundary normal component in the normal component of the boundary of the identified one object element. The two-dimensional plane is a two-dimensional plane on which the three-dimensional model M1 is projected when the user designates the boundary plane component. The near side means a side on which the virtual camera is disposed with respect to the normal direction of the two-dimensional plane.

The estimation unit 123 divides the three-dimensional provisional model into the plurality of object elements by inputting the three-dimensional provisional model to the object recognizer. The object recognizer is a recognizer generated by machine learning to recognize a predetermined object element in an input three-dimensional provisional model. For example, in a case where the three-dimensional provisional model to be input is an electronic component unit, the object recognizer recognizes object elements such as a circuit board, an integrated circuit, a connector group, and a circuit element group. The recognition result output from the object recognizer includes position data indicating a three-dimensional region in which each of the plurality of object elements recognized in the input three-dimensional provisional model is disposed, and a label of each of the plurality of recognized object elements.

The processing of the information processing device 1 according to the second embodiment will be described below. A main routine of the processing in the second embodiment is the same as the flowchart of FIG. 2 described in the first embodiment. However, since details of the cutout processing in step S3 of FIG. 2 are different from those of the first embodiment, the details of the cutout processing will be described below.

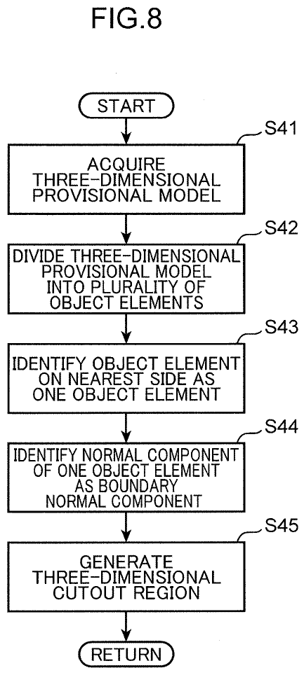

FIG. 8 is a flowchart illustrating the details of the cutout processing according to the second embodiment. In step S41, the estimation unit 123 acquires the three-dimensional provisional model generated by the provisional model generation unit 122 from the memory 11.

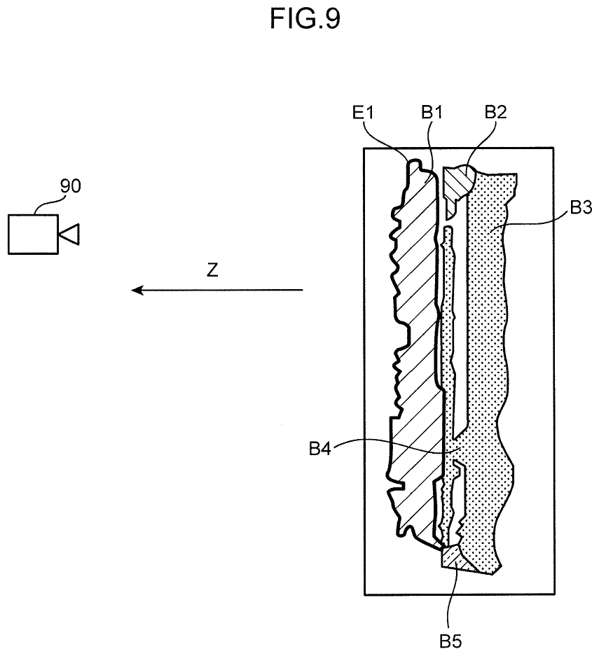

In next step S42, the estimation unit 123 divides the three-dimensional provisional model into the plurality of object elements by inputting the three-dimensional provisional model to the object recognizer. FIG. 9 is a diagram illustrating the plurality of object elements obtained by dividing the three-dimensional provisional model. As illustrated in FIG. 9, the three-dimensional provisional model is divided into a plurality of object elements B1 to B5. In this example, the three-dimensional provisional model is divided into the five object elements B1 to B5, but this is an example, and the three-dimensional provisional model may be divided into 2 to 4 or 6 or more object elements. The number of divided object elements varies depending on the type of the input three-dimensional provisional model and the number of object elements to be recognized by the object recognizer.

In next step S43, the estimation unit 123 identifies one object element disposed on the nearest side among the divided object elements B1 to B5. In the example of FIG. 9, the direction where the virtual camera 90 is disposed is set to a normal direction Z. The nearest side means the side closest to the virtual camera 90 in the normal direction Z. Among the object elements B1 to B5, the object element B1 is disposed closest to the virtual camera 90 in the normal direction Z. Therefore, the object element B1 is identified as one object element.

In next step S44, the estimation unit 123 identifies a normal component of one object element as a boundary normal component of the three-dimensional cutout region M2. In the example of FIG. 9, the normal component of the object element B1 indicated by a thick line E1 is identified as the boundary normal component.

In next step S45, the cutout unit 124 extracts a point surrounded by the boundary normal components from the three-dimensional provisional model, and generates a model including the extracted point as the three-dimensional cutout region.

According to the second embodiment, the three-dimensional provisional model is divided into the plurality of object elements, and the boundary normal component is determined in the normal component of the boundary of the object element located on the nearest side among the plurality of divided object elements, thereby accurately estimating the boundary normal component.

### Modifications Described Below can be Adopted for the Present Disclosure

(1) In the second embodiment, the plurality of object elements are obtained by inputting the three-dimensional provisional model to the object recognizer, but the present disclosure is not limited thereto. The estimation unit 123 may divide the three-dimensional provisional model into the plurality of object elements by applying clustering processing to the three-dimensional provisional model. As the clustering processing, for example, hierarchical clustering may be adopted, or non-hierarchical clustering such as a k-means method may be adopted.

(2) In FIG. 1, the information processing device 1 is configured by a standalone computer, but the present disclosure is not limited thereto, and the information processing device 1 may be configured by a cloud server. In this case, the information processing device 1 is communicably connected to a remote terminal via a network such as the Internet. In this case, the information processing device 1 may acquire an input instruction to designate the boundary plane component from the remote terminal. Further, in this case, the information processing device 1 may transmit, to the remote terminal, display data for displaying the display screens G1 and G2 on the remote terminal.

(3) Although the three-dimensional master data includes three-dimensional CAD data, the present disclosure is not limited thereto, and may include any data as long as the data is three-dimensional data to be a reference indicating an object. For example, the three-dimensional master data may be building information modeling (BIM) data.

The present disclosure is useful in the technical field of cutting out an attention region from a three-dimensional model.

1. An information processing method in a computer, the method comprising:
acquiring an input instruction to designate a boundary plane component that is a plane component of a boundary of a three-dimensional cutout region cut out from a three-dimensional model of an object on a two-dimensional plane on which the three-dimensional model is projected;
generating a three-dimensional provisional model demarcated by the boundary plane component in the three-dimensional model;
estimating a boundary normal component of the three-dimensional cutout region by correcting a shape of the three-dimensional provisional model, the boundary normal component being a component in a normal direction orthogonal to the two-dimensional plane,
cutting out a region demarcated by the boundary normal component from the three-dimensional provisional model, as the three-dimensional cutout region; and
outputting the three-dimensional cutout region.

2. The information processing method according to claim 1, wherein
the estimating the boundary normal component includes
acquiring three-dimensional master data of the object,
detecting, in the three-dimensional provisional model, a point conforming to the three-dimensional master data by matching the three-dimensional master data with the three-dimensional provisional model, and
estimating a component in a normal direction of the conforming point as the boundary normal component.

3. The information processing method according to claim 2, wherein
the matching includes
detecting a feature point of the three-dimensional master data and a feature point of the three-dimensional provisional model,
comparing a feature amount of the feature point of the three-dimensional master data with a feature amount of the feature point of the three-dimensional provisional model, and detecting, in the three-dimensional master data, the feature point of the three-dimensional master data matching with the feature point of the three-dimensional provisional model, and
detecting the feature point of the three-dimensional provisional model at which the matching feature point can be detected, as the conforming point.

4. The information processing method according to claim 2, wherein the three-dimensional master data is three-dimensional computer aided design (CAD) data of the object.

5. The information processing method according to claim 1, wherein
the estimating the boundary normal component includes
dividing the three-dimensional provisional model into a plurality of object elements constituting the object,
identifying, among the plurality of object elements, one object element disposed on a nearest side of the two-dimensional plane, and
determining the boundary normal component in a component in a normal direction of a boundary of the one object element.

6. The information processing method according to claim 5, wherein the plurality of object elements are obtained by inputting the three-dimensional provisional model to an object recognizer.

7. The information processing method according to claim 5, wherein the plurality of object elements are obtained by clustering the three-dimensional provisional model.

8. The information processing method according to claim 1, wherein
the boundary plane component includes a plurality of sides partitioned by a plurality of vertexes,
the generating the three-dimensional provisional model includes
calculating, for a plurality of side vectors corresponding respectively to the plurality of sides, outer products of attention point vectors and the plurality of side vectors, the attention point vectors connecting start points of the plurality of side vectors to attention points, the attention points indicating respectively all points constituting the three-dimensional model,
extracting, from all of the points, an attention point at which all of the outer products calculated respectively for the plurality of side vectors are positive, and
identifying the extracted attention point as a point of the three-dimensional provisional model.

9. An information processing device comprising a processor,
wherein the processor
acquires an input instruction to designate a boundary plane component that is a plane component of a boundary of a three-dimensional cutout region cut out from a three-dimensional model of an object on a two-dimensional plane on which the three-dimensional model is projected,
generates a three-dimensional provisional model demarcated by the boundary plane component in the three-dimensional model,
estimates a boundary normal component of the three-dimensional cutout region by correcting a shape of the three-dimensional provisional model, the boundary normal component being a component in a normal direction orthogonal to the two-dimensional plane,
cuts out a region demarcated by the boundary normal component from the three-dimensional provisional model, as the three-dimensional cutout region, and
outputs the three-dimensional cutout region.

10. A non-transitory computer readable recording medium storing an information processing program for causing a computer to perform processing of:
acquiring an input instruction to designate a boundary plane component that is a plane component of a boundary of a three-dimensional cutout region cut out from a three-dimensional model of an object on a two-dimensional plane on which the three-dimensional model is projected;
generating a three-dimensional provisional model demarcated by the boundary plane component in the three-dimensional model;
estimating a boundary normal component of the three-dimensional cutout region by correcting a shape of the three-dimensional provisional model, the boundary normal component being a component in a normal direction orthogonal to the two-dimensional plane,
cutting out a region demarcated by the boundary normal component from the three-dimensional provisional model, as the three-dimensional cutout region; and
outputting the three-dimensional cutout region.
